(19) United States
(12) Patent Application Publication
(10) Pub. No.: US 2006/0068094 A1
(43) Pub. Date: Mar. 30, 2006

(54) Production paint shop design

(76) Inventor: David J. Cole, Canton, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 10/952,694

(22) Filed: Sep. 29, 2004

(51) Int. Cl. B05C 13/00; B05B 15/12

(52) U.S. Cl. 427/240; 118/320; 118/308; 118/326; 118/64

(57) ABSTRACT

A paint application facility including a paint booth assembly for applying paint to automotive vehicles each defining a longitudinal axis includes a carrier adapted to serially move a plurality of automotive vehicles through the booth assembly in a direction generally perpendicular to the longitudinal axis of the vehicle.

### BACKGROUND OF THE INVENTION

Painting automobile bodies has progressed to require a significant amount of advanced technology housed in painting facilities costing of hundreds of millions of dollars. These paint facilities receive unfinished “body in white” vehicle bodies from a body shop for paint processing and transfer painted and sealed bodies to final assembly facilities where the vehicle is completely assembled. A typical paint facility requires up to a third or more of an assembly plant floor space, which is exceedingly costly adding to the cost of painting a vehicle body in terms of both facility construction and energy requirements for maintaining the paint facility.

Various attempts have been made to adjust the processing orientation of vehicle bodies through paint shops. However, the primary focus of these concepts are directed toward pretreatment and electro deposition primer tanks. One such concept is shown in U.S. Pat. No. 6,419,983, Method of Introducing and Removing Workpieces, Particularly Vehicle Bodies, An Apparatus and System for the Surface Treatment of Workpieces. This concept discloses a conveyor system where vehicle bodies are rotated, end over end, and submerged at steep angles into the various pretreatment and e-coat tanks for improving the conversion coating and electrodeposition primer application and enabling the tank length to be shortened from conventional tank lengths. Further concepts have been shown in U.S. Pat. No. 6,676,755, Installation for Treating, Especially Painting, Objects, Especially Vehicle Bodies, and U.S. Pat. No. 6,673,153, Treatment Plant, and Particularly for Painting Objects, In Particular Vehicle Bodies. These patents also are directed toward pretreatment and electro deposition primer tanks and require complex conveyor systems enabling vehicle bodies to be submerged in the various tanks at steep angles allowing the tank size to be reduced.

None of the prior art patents have addressed the need to reduce the overall paint application facility size by reducing the size of the various paint booths and ovens required to apply and secure subsequent paint coatings such as, for example, primer surfacer, base coat, and clear coat. Therefore, it would be desirable to introduce a new paint shop configuration that would enable the reduction in overall size of the paint shop providing both reduced capital cost to construct the paint application facility and reduced energy requirements to operate the facility.

Additionally, conventional paint application booths support vehicle bodies in longitudinal orientation on a conveyor centrally located inside the booth. The paint application booth generally provides a downwardly directed flow of air to remove particulate paint not adhered to the vehicle body, known as overspray, into flowing water disposed beneath the conveyor. However, much of this overspray is known to adhere to the conveyor, which results in frequent cleaning. This is known to result in contaminants in the paint application booth causing defects in the paint coating. Furthermore, the various paint technologies presently in use, including, urethanes, water borne based paints, and powder paint, require a precise airflow balance inside the booth in the absence of air turbulence to apply an even, high quality paint coating. Locating process equipment inside the booth is known to cause turbulent airflow. Attempts have been made to reduce the amount of application equipment located inside and access to the various paint application booths to improve the airflow characteristics through the booth thereby reducing the resultant dirt and contaminants inside the booth. However, no attempts have been made to reduce the impact of the conveyor upon the airflow through the booth.

Therefore, it would be desirable to provide a conveyor configuration that reduces the impact of the conveyor upon the balanced flow of air and amount of dirt inside the paint application booth. More preferably, it would be desirable to simultaneously achieve the benefits of a reduced paint application facility size and a reduction in the adverse effects of presently available conveyor systems upon the quality of the decorative paint finish being applied to the vehicle bodies.

### SUMMARY OF THE INVENTION

A paint booth assembly is adapted to apply coatings to a plurality of vehicle bodies moving serially through the paint booth. The vehicle bodies define a longitudinal axis and move through the paint booth in a direction that is generally perpendicular to the longitudinal axis of the vehicle.

As stated above, prior art paint application facilities process automotive vehicle bodies moving upon a conveyor in a direction generally parallel to the longitudinal axis of the vehicle bodies. This is best represented in FIG. 1 where a top portion of the schematics shows a conventional direction of movement of various vehicle bodies 12 in the direction of the vehicle bodies 12 longitudinal axis. As is known to those of skill in the art, a specific distance, generally known to prevent overspray from a first vehicle body 12 to a second vehicle body 12 is required due to the necessity of painting adjacent vehicle bodies 12 with different colors. The spacing is generally about eight feet and is represented by a gap 13 in FIG. 1. The speed of a conveyor that transfers vehicle bodies 12 through a paint application booth is restricted by the ability to atomize and apply a quality paint coating to the vehicle. The faster a conveyor moves, the higher the paint flow rate through paint application equipment must be. As the paint flow rate increases, the paint finish quality on the vehicle is known to decrease. Therefore, to increase the number of vehicle bodies being processed through a paint application facility, a paint application booth is typically made longer and additional paint application stations are required. Furthermore, present application technology prevents reducing the gap 13 disposed between adjacent vehicle bodies 12 to increase the rate of vehicle bodies being processed.

Orienting the vehicle bodies serially in a side by side relationship and moving the vehicle bodies through the various paint application booths and tanks, as represented in the lower portion of FIG. 1, enables nearly twice as many vehicles to be processed over conventional vehicle orientation even when the conveyor is moving at the same conveyor speed.

Two benefits are derived by moving the vehicles at a generally perpendicular direction in a longitudinal axis of the vehicles. First, the conveyor may be slowed down to half its conventional speed while processing the same vehicle rate, which will improve paint finish quality by enabling a reduction in the flow rate of particulate paint in the paint application equipment. Second, through processing vehicles upon a conveyor moving at its original rate enables twice as many vehicles to be processed. Furthermore, some combination of a partial reduction in line speed and a partial reduction in paint flow rate produces an improved paint finish while still increasing a vehicle processing rate through the paint application facility.

The novel paint application facility design associated with the present invention, uses a new conveyor orientation by moving the conveyors to the outer wall of the various paint application tanks and booths. Alternatively, the conveyors are located outside the booth eliminating all contact of the conveyors with the particulate paint being applied to the vehicle bodies. In either case, an improved airflow quality is derived inside the paint booth which results in improved paint quality and a reduction in paint defects.

Furthermore, paint shop construction economies of scale are derived by processing vehicle bodies through the paint booth and ovens in a direction that is generally perpendicular to the longitudinal axis of the vehicle. The wide range of vehicle bodies, such as, for example, compact vehicles, midsize vehicles, utility vehicles, and most vans have generally constant widths while the vehicle lengths vary significantly. Painting vehicle bodies moving in this orientation provides the benefit of commonizing paint shop design, even between a paint shop designed to paint a compact size vehicle and a paint shop designed to paint a utility vehicle because the length of the paint booth and ovens are is now determined by the width of the vehicles and not the length. Therefore, unlike prior art designs, many of the engineering and fabricating processes that are changed for each paint shop construction are now common and can be re-used or re-processed.

### BRIEF DESCRIPTION OF THE DRAWINGS

Other advantages of the present invention will be readily appreciated as the same becomes better understood by reference to the following detailed description when considered in connection with the accompanying drawings wherein:

FIG. 1 is a schematic comparison of standard vehicle orientation in paint application facilities versus the inventive vehicle orientation of the present invention;

FIG. 2 is an overhead schematic layout of an inventive paint application facility of the present concept;

FIG. 3 is a side schematic view of one preferred embodiment of the inventive paint application facility;

FIG. 4 is a front sectional view of one embodiment of the subject inventive paint application booth;

FIG. 5 is a front sectional view of a further embodiment of the subject inventive paint application booth;

FIG. 6 is a front sectional view of a further embodiment of the subject inventive paint application booth showing rotational movement of a vehicle body;

FIG. 7 is a front sectional view of a further embodiment of the subject inventive paint application booth showing alternate paint applicators;

FIG. 8 is a schematic plan view of the subject inventive paint application booth; and

FIGS. 9A-9H show a schematic view of rotary apparatus along a longitudinal axis of the vehicle body.

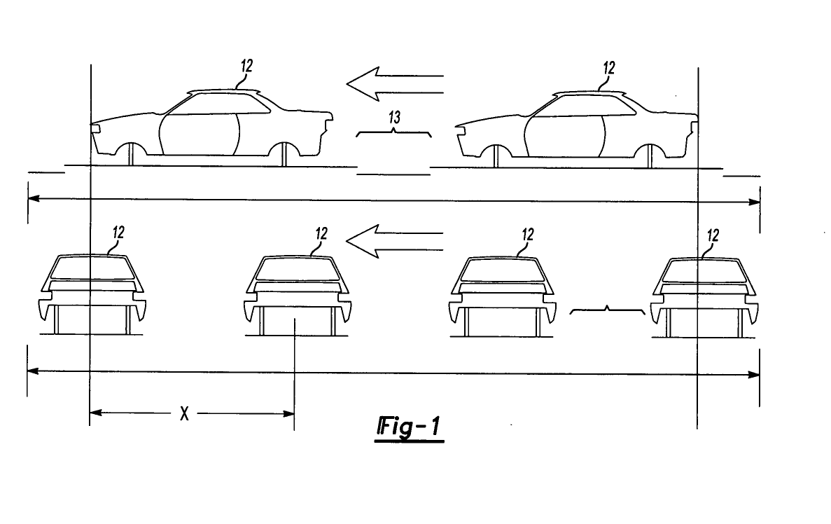

### DETAILED DESCRIPTION OF THE PREFERRED EMBODIMENT

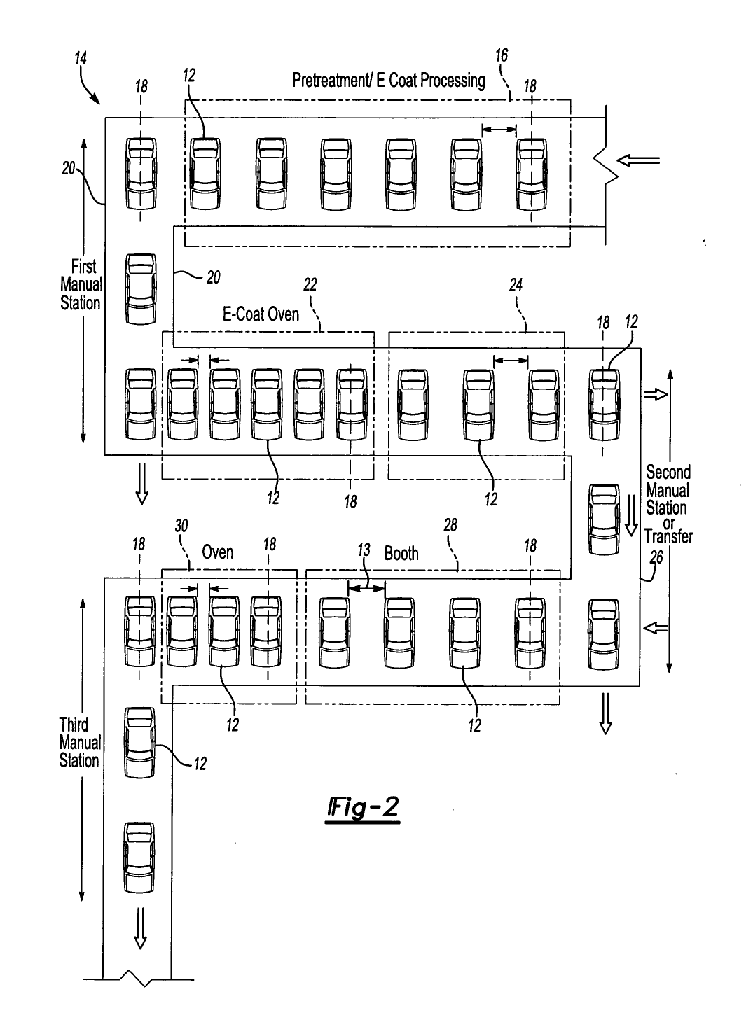

Referring to FIG. 2, one preferred arrangement of the inventive paint application facility is generally shown at 14. In this embodiment, like conventional paint application facilities, vehicle bodies 12 are initially introduced to the paint application facility from a body fabrication shop (not shown). The first processing step of the vehicle bodies 12 are processed in pretreatment and electrodeposition coating tanks. As is known to those of skill in the art, a pretreatment station cleans and treats the vehicle body, known as body-in-white, with a phosphate coating to improve paint adhesion and reduce corrosion of the vehicle body. The pretreatment station uses several immersion and spray clean, rinse, and conversion tanks to apply a high quality phosphate coating to the body-in-white. Subsequent to the pretreatment station, the vehicle body 12 is cleansed with deionized water and submerged in an electrodeposition tank where electrocoat paint is applied.

The vehicle bodies 12 are processed serially, in a side by side relationship through pretreatment and e-coat stations 16 enabling a significant reduction in the length of the various pretreatment tanks and e-coat tank. In other words, each vehicle defines a longitudinal axis represented as 18 in FIG. 2 and is moved in a generally perpendicular direction to the vehicle axis 18. The dimensional relationship between the vehicle bodies 12 and the reduction in overall length of the pretreatment and electrocoat processing tanks will be explained further below.

Subsequent to processing through the electrodeposition primer coating, the vehicle bodies 12 are subjected to a deionized water rinse, and occasionally a subsequent manual operation as indicated in a first manual station 20 of FIG. 2. As known to those of skill in the art, a first manual station 20 is primarily used as an inspection station in contact with the uncured electrodeposition primer coating is not recommended. However, to enable easy access to each vehicle body 12, it is preferred that the direction of movement of each vehicle body be along a longitudinal axis 18 at the first manual station. The purpose for this new orientation will become evident and further explained below.

Immediately following the first manual station 20 is an electrodeposition primer oven 22 where the electrodeposition primer is cured. Preferably, the vehicle bodies 12 are again oriented in a side by side relationship for processing through the oven 22. With appropriate oven thermal balancing, the gap disposed between each vehicle body 12 is narrowed, further shortening the overall length of the oven 22. As should be known to those of skill in the art, the electrodeposition primer oven 22 now requires only approximately half the length of a conventional oven. Appropriate oven thermal balancing is easily achieved through the use of thermal couples to determine the appropriate oven 22 zone temperatures for processing the vehicles 12 in a side by side relationship.

Subsequent to the electrodeposition primer oven 22, the vehicle bodies 12 are transferred through a miscellaneous station 24 where the preferred vehicle gap between adjacent vehicle bodies 12 is optionally returned depending on processing leading to a second manual work station 26. The miscellaneous station includes such processing as, for example, the application of stone guard.

A second manual work station 26 is configured to again return the vehicle bodies 12 to a longitudinal transfer generally aligned with the axis 18 of the vehicle bodies. Manual operations include, but are not limited to, tack off sealing operations, fixture installations, electrodeposition primer sanding, and inspection. It is believed that moving the vehicle bodies 12 in a direction generally parallel to the longitudinal vehicle access facilitates manual processing as will be explained further below.

Preferably, the vehicle bodies 12 are again oriented in a side by side relationship just prior to entering both the primer surfacer booth and the paint application booth 28. For the purposes of discussion, and as shown in FIG. 2, the “booth” 28 represents both the primer surfacer booth and the paint application booth. As is known to those of skill in the art, the primer surfacer booth 28 precedes the top coat paint application booth and is separate by a primer surfacer oven. Throughout the explanation of FIG. 2, references to the “booth” 28 refer to both the top coat paint application booth and the primer surfacer booth for clarity. Furthermore, references to the “oven” 30 should be understood to be a reference to both the primer surfacer oven and the top coat oven.

Benefits derived through processing the vehicle bodies 12 in the aforementioned orientation are most noticeably derived in the paint application booth 28. As set forth above, the application booth 28 is shortened by up to half the length of a conventional booth significantly reducing the application facility floor space required to apply primer surfacer and top coat to the vehicle bodies 12. Generally, the gap 13 disposed between each of the vehicles 12 inside the booth 28 is preferred to be about eight feet. This gap is required whether or not the vehicles are processed in a side by side manner or processed along the longitudinal axis 18 to prevent overspray from one vehicle body 12 to collect upon an adjacent vehicle body 12. While being transferred through the oven 30, the gap disposed between each of the vehicles 12 is significantly less than four feet, further shortening the overall length of the oven 30. The oven 30 requires a wider footprint over conventional designs, however, the booth 28 retains substantially the same width as that of a conventionally designed booth. Once the vehicles bodies 12 have been transferred from the oven to a third manual station 32, the vehicle bodies 18 are again returned to move along the longitudinal axis 18 to facilitate remaining manual operations such as, for example, removing process fixtures, final paint inspection, and wet sanding the clear coat when necessary.

A statistical average was take of over seventy vehicle bodies 12 having a variety of body types including, compact vehicles, midsize vehicles, full size vehicles, vans, sport utility vehicles, and pickup trucks. The calculated variance of the length of these sampled vehicles was sixty nine inches while the calculated variance of the width of these vehicles was only 22.3 inches. Given these variances, it is believed that a single paint process equipment configuration can be used to paint each of these vehicle bodies allowing a significant reduction in duplicated design and additional fabrication over present paint shops that process vehicle bodies 12 in an end to end relationship. Therefore, regardless the vehicle type, the processing equipment is oriented on a common pitch, even if the width of the application booths vary slightly between, for example, a compact vehicle body and a full size pickup truck. This provides the ability to harmonize mechanical designs, controls, facility layout, and facility foot print consistently as opposed to rarely as is presently the practice.

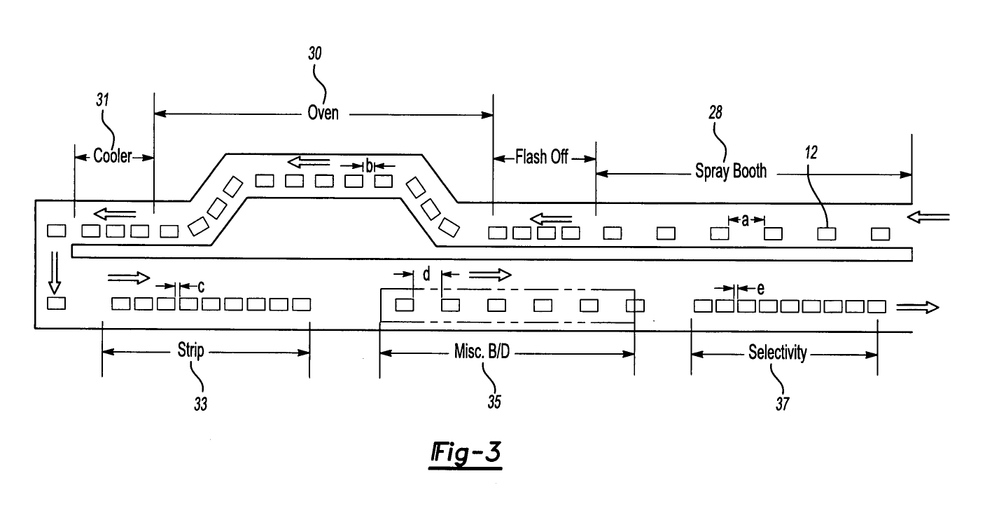

FIG. 3 represents a side schematic of one preferred embodiment of a paint application facility 14 beginning with the spray booth, wherein base coat and clear coat paint are applied to the vehicle bodies 12 being conveyed through the booth 28. In this embodiment, the vehicle bodies 12 are spaced a booth distance a, generally about 8 feet, in a side by side relationship. Booth distance a is preferred to be the minimum distance required to prevent paint overspray from contaminating adjacent vehicles 12. In the event large blocks of vehicle are painted with the same color, the booth distance a is shortened to as little as four feet or less.

A flash off zone 29 is positioned subsequent to the paint booth 28, where solvent evaporates from the uncured paint adhered to each of the vehicle bodies 12. In the flash off zone 29 and the following bake oven 30, the vehicle bodies 12 are preferably spaced apart an oven distance b, which is less than the booth distance a. The oven distance b need merely be that distance required to allow for a uniform heat transfer to each vehicle body inside the oven 30 to provide adequate paint curing. It is believed that the oven distance b is as little as two feet or less.

A transfer line and/or strip out 33 is located subsequent to a cooler 31, which blows cool air onto the hot vehicle bodies 12 to rapidly bring down the temperature of the vehicle bodies 12 exiting the paint oven 30. Vehicle bodies 12 in each of these zones 31, 33 are spaced a strip out distance c, which is less than or greater than distances a and b respectively, or as required to facilitate transfer of the vehicle bodies 12 to subsequent operations. Furthermore, the vehicle bodies 12 alternatively are rearranged into an end to end relationship if necessary in these zones 31, 33.

Miscellaneous zones 35, where inspections, minor repairs, and fixture removal take place are located after the oven strip out zone 33. In these miscellaneous stations 35, the vehicle bodies 12 are spaced a miscellaneous zone distance d that enables workers to access the vehicles bodies 12 to perform the requisite functions. Additionally, it may be necessary to again rotate the vehicle bodies 12 to an end to end serial relationship to provide the required access set forth above.

As known to those of skill in the art of paint application facility construction, the final stage of the paint application process is the selectivity zone 37. The vehicle bodies 12 are again, preferably, positioned in a side by side relationship and conveyed in a direction generally perpendicular to the longitudinal axis of each vehicle body 12. The selectivity zone 37 is merely where the defectively painted vehicle bodies are cycled back to a repair zone (not shown). Therefore, the distance between each body, represented by selectivity zone distance e is very narrow, preferably less than two feet.

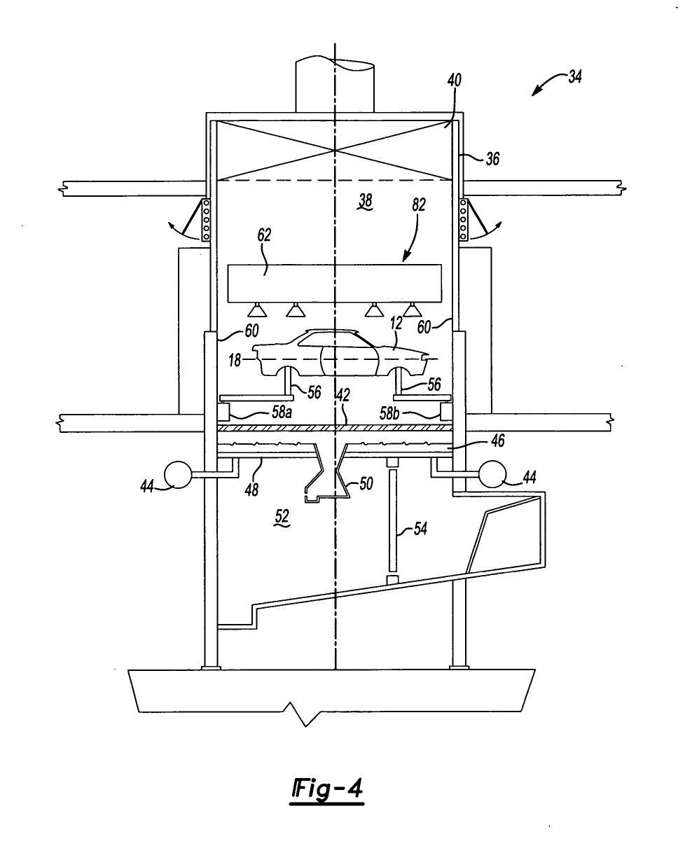

Referring to FIG. 4, a first preferred embodiment of the paint application booth assembly is generally shown at 34. A paint booth 36, as known to those of skill in the art, defines a paint application chamber 38 through which vehicle bodies 12 are conveyed for the application of atomized paint. The atomized paint includes solvent borne, water borne, and powder paint as required by various paint operations. As set forth above, each vehicle body 12 is conveyed in a generally perpendicular direction to the longitudinal axis of the vehicle 12. An air plenum 40 receives a source of pressurized air at a desired volumetric flow rate from an air fan (not shown) and provides a balanced flow in a downward direction through the paint application chamber 38. The flow of air forces overspray paint downwardly through a porous floor 42 generally formed from a plurality of removable grates. Beneath the grates, a plurality of pumps 44 provide a sheet of water 46 that flows across a lower surface 48 defining the bottom of the paint application chamber 38. The overspray paint is forced by the flow of air into the sheet of water 46, which has been treated with various paint detacification and agglomeration chemicals that allow paint to be removed from the water and treated as hazardous waste.

Below the lower surface 48, at least one scrubber 50 receives the sheet water 46 and transfers the water 46 into a separation chamber 52. A series of baffles 54 receive the water and paint mixture in the separation chamber 52 providing additional intermixing of the chemicals disposed in the water 46. Subsequently, the water 46 and paint particles are transferred to a filtration station (not shown) and returned to the water pumps 44 for reuse in a like manner. Various preferred embodiments of the filtration systems are disclosed in U.S. Pat. No. 6,716,272, Scrubber for Paint Booths, U.S. Pat. No. 6,666,166, Spraybooth Scrubber Noise Reflector, U.S. Pat. No. 6,623,551, Baffle System for Separating Liquid From A Gas Stream, and U.S. Pat. No. 5,512,017, Paint Spray Booth and Supply Plenum Arrangement, the details of which are incorporated in this application by reference.

Each vehicle body 12 is supported upon a vehicle carrier 56 which is conveyed by at least one conveyor 58 through the paint application chamber 38. Preferably, the conveyor 58 is located adjacent a booth wall 60 to reduce the turbulent effect of blocking the flow of air 30 through the application chamber 38, which is received from the plenum 40. As represented in FIG. 4, two conveyors 58a and 58b support opposing ends of the vehicle carrier 56 providing conveying movement in a vehicle body 12, where each conveyor 58a, 58b is located adjacent opposing booth walls 60. Alternatively, only the first conveyor 58a provides conveying movement to the vehicle body 12 while the second conveyor 58b merely supports the vehicle carrier 56 cooperatively with the first conveyor 58a.

Preferably, paint applicators 82 are disposed above in the vehicle bodies 12 and are represented in FIG. 4 as overhead reciprocators 62, which, as known to those of skill in the art, atomize and ionize paint being applied to the grounded vehicle body 12 providing a high level of paint transfer efficiency. In this embodiment, paint is sprayed in a downward direction toward each vehicle body. One preferred method of applying paint to the sides of each vehicle body 12 is explained further below.

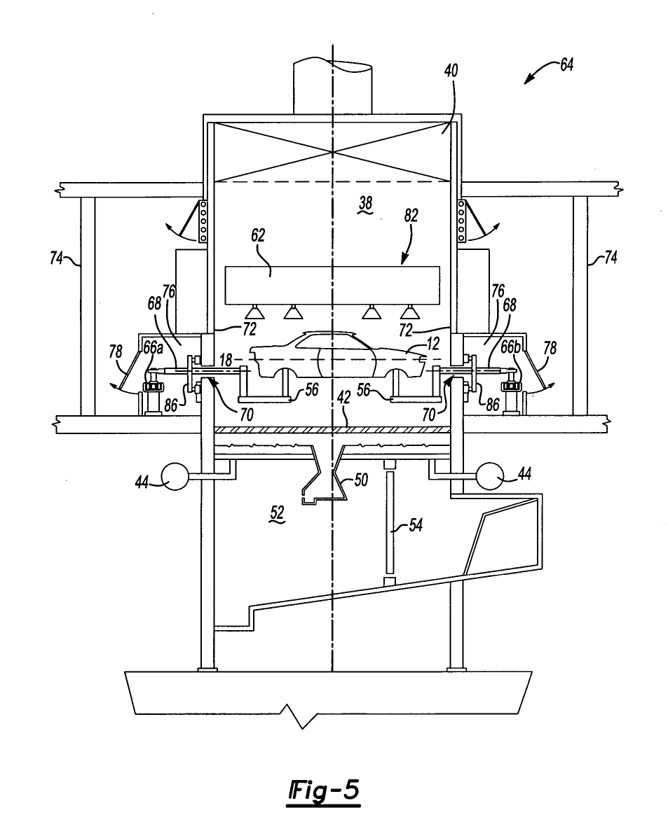

Referring now to FIG. 5, an alternative embodiment is generally shown at 64. In this embodiment, a conveyor 66 has been completely removed from the paint application chamber 38 further reducing, and even eliminating, the impact of conveying the vehicle body 12 through the application chamber 38 upon the balanced flow of air provided by the air plenum 40. As indicated with the previous embodiment, the alternate conveyor 66 includes first and second conveyors 66a, 66b, at least one of which provides conveying movement to the vehicle body 12. The second conveyor 66a, 66b alternatively provides driving movement to the vehicle body 12 or acts as a dummy conveyor for balancing the carrier 56.

The vehicle carrier 56 is modified to include the elongated members 68, which extend through a slot 70 disposed in an alternate booth wall 72. The slot 70 extends the entire length of the alternate booth 64, or alternatively, the full extent of which the alternate conveyor 66a, 66b is disposed outside the paint application chamber 38.

A truss 74 or other support is disposed outside the application chamber 38 to support the upper potion of the alternate paint booth 64 enabling the slot 70 to extend the full length of the alternate booth 64. The alternate conveyor 66a, 66b are preferably disposed within a conveyor chamber 76, which is sealed by access door 78 from the outside environment. Preferably, the paint application chamber 38 has a slightly higher air pressure than that of the conveyor chamber 76 to prevent contaminants disposed in the conveyor chamber 76 from entering the paint application chamber 38 through the slot 70.

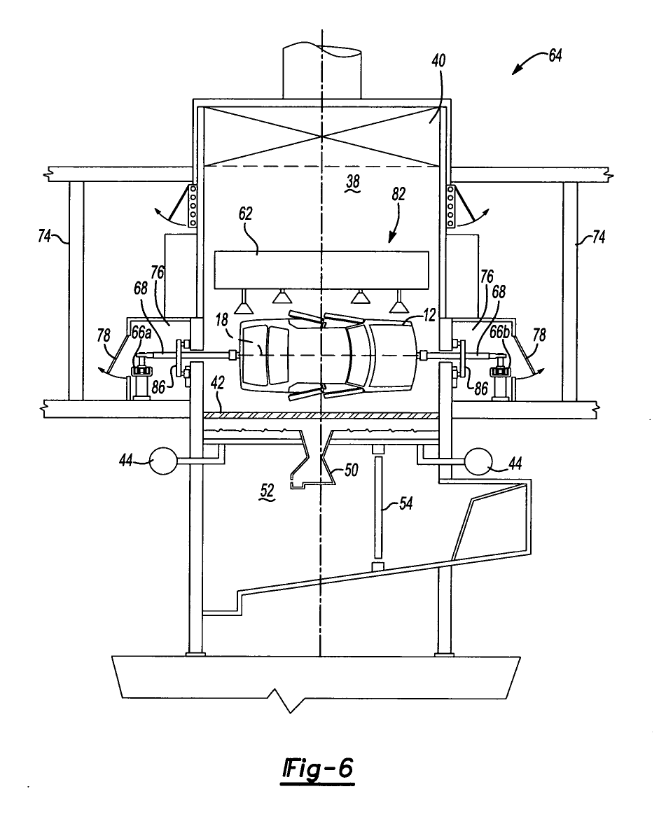

Preferably, the elongated members 68 are aligned with a rotational axis 18 of the vehicle body 12, the purpose of which is shown in FIG. 6. The vehicle body 12 is shown rotated upon its axis 18 90 degrees enabling the overhead reciprocator 62 to apply particulate paint to the sides of the vehicle body 12. This provides the benefit of eliminating side paint application machines from the paint application chamber 38 providing further cost savings to the paint application facility construction and simplifying the paint application requirements. Additionally, it is believed that several advantages may be derived by applying paint to the rotating vehicle body 12 in a downward direction such as, for example, improved paint efficiency and paint quality.

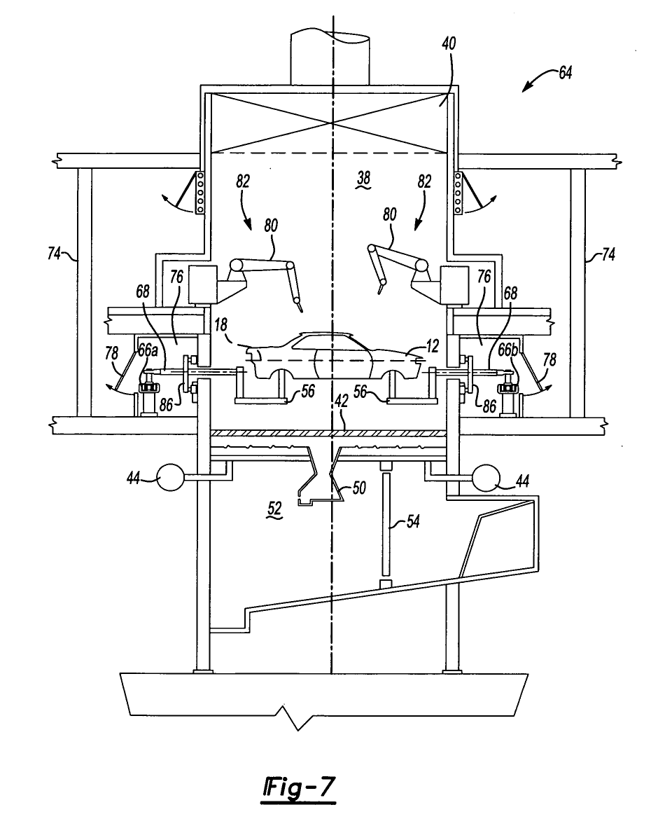

FIG. 7 shows an alternative method of applying paint to the vehicle body 12 by using robotic paint applicators 80 as opposed to overhead reciprocators. The robotic paint applicators 80 provide the benefit of improved access to concealed areas such as seams formed between vehicle doors and the vehicle body 12. Additionally, an optimum combination of overhead reciprocator 62 and robotic applicators 80 is believed to provide optimum paint efficiency and quality on different types of vehicle bodies. It is further believed that robotic paint applicators 80 are required for use with conveyors 58, 66 that do not provide rotational movement to the vehicle body 12 to facilitate the application of paint to the concealed areas of the vehicle body referenced above. A still further alternate embodiment provides the benefit of the robotic paint applicator 80 or the overhead reciprocator 62 traveling with the moving vehicle body 12 to provide a single source of paint application.

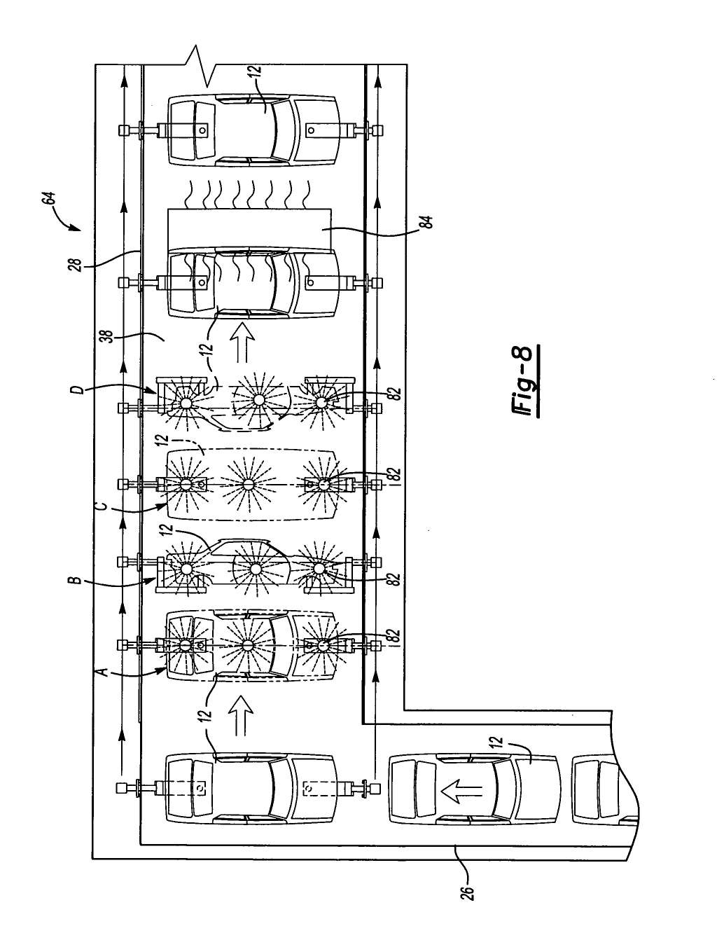

Referring now to FIG. 8, one preferred embodiment, is shown as a schematic of rotational paint application to vehicle bodies serially moving through the paint booth 64. Position A shows a first paint application orientation for the vehicle body 12 where atomized paint is applied by applicator 82 to the top surfaces of the vehicle body 12. Position B shows the vehicle body 12 rotated ninety degrees where the paint applicator 82 applies atomized paint to a first side of the vehicle body 12. Position C shows the vehicle body 12 rotated 180 degrees so that the applicator 82 applies atomized paint, if required, to the underside of the vehicle body 12. Position D represents the vehicle body 12 rotated 270 degrees so that the paint applicators 82 apply paint to the remaining side of the vehicle body 12. While FIG. 8 shows a series of paint applicators 82, it should be understood where a single paint applicator 82 moving along with the vehicle body 12 applies paint to each side of the vehicle body and returns to an original position to apply paint to a following vehicle body 12. As stated above, additional operations may be required such as, for example, opening doors to apply paint to restricted areas, which requires additional robotic manipulators working in cooperation with either the overhead reciprocators 62 or the robotic paint applicators 80. Subsequent to paint application, a solvent flash zone as known to those of skill in the art, is provided prior to the vehicle bodies 12 entering the paint oven 30. If necessary, a heated flash apparatus 84 is provided to reduce the between base coat and clear coat application to more rapidly evaporate solvents disposed in the base coat thereby reducing the distance necessary between the base coat and clear coat application stations.

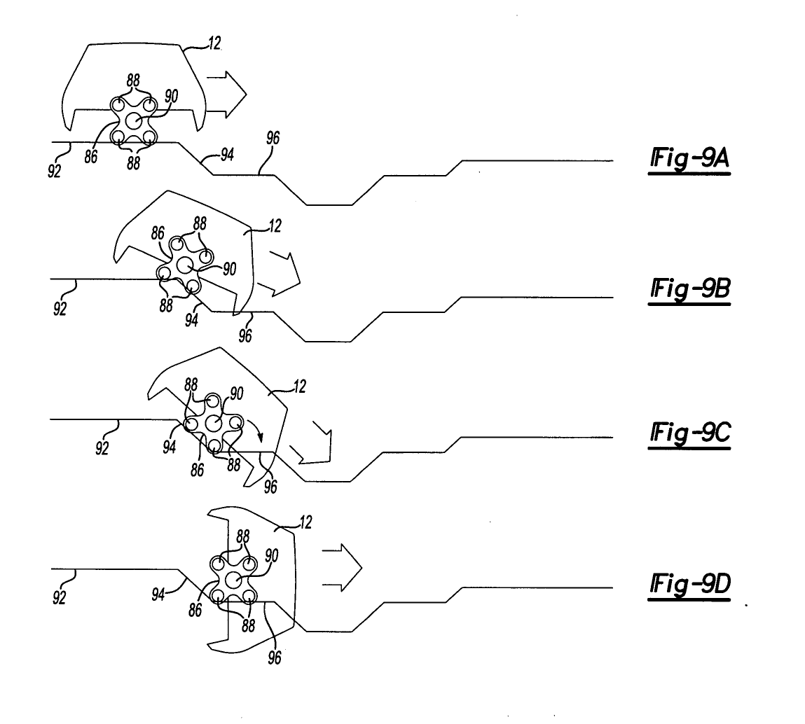

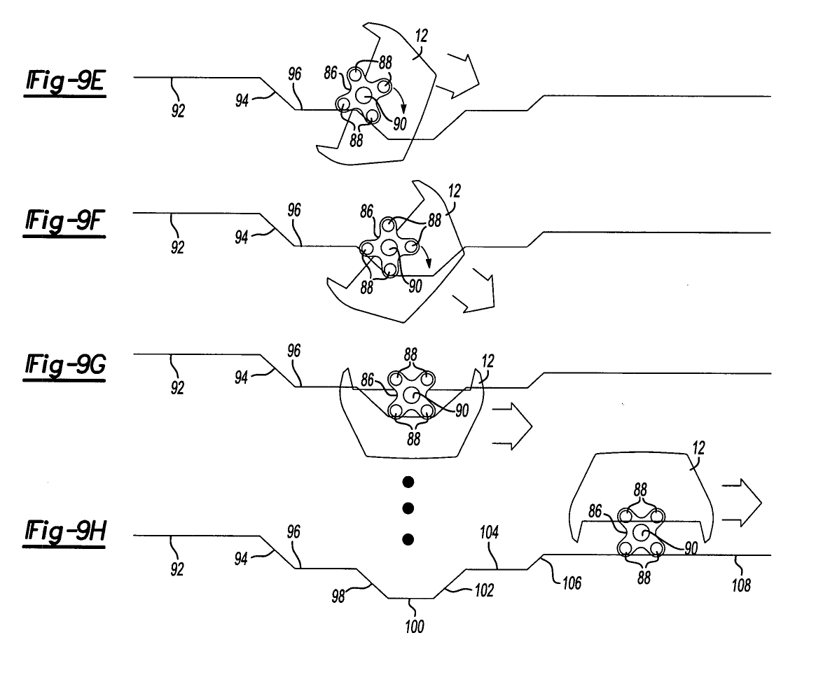

FIGS. 9A through 9H show one preferred conveyor embodiment providing rotational movement to the vehicle body through the paint application chamber 38. A camming member 86 preferably includes four camming arms 88 equally spaced around an axis point 90 defined by the elongated member 68 of the vehicle carrier 56. At least two camming arms 88 ride upon a cam 92 supporting the vehicle body 12 in an upright position during initial application of the paint to the vehicle body 12 as shown in FIG. 9A. Referring to FIG. 9B, the camming arms 88 begin to interface with a second cam 94 beginning the initial rotational movement of the vehicle body 12 as shown in FIG. 9C and ending in FIG. 9D where two camming arms 88 are supported by the third cam 96. In this position, the vehicle body 12 is oriented for application of paint from the applicator 82 to a side surface of the vehicle body 12. The paint applicator 82 continuously applies atomized paint to the vehicle body 12 during rotational movement through FIGS. 9B and 9C. Alternatively, paint application is terminated during the vehicle 12 rotation shown in FIGS. 9B and 9C and is reinitiated at the vehicle orientation shown in FIG. 9D. As shown in FIGS. 9E through 9G, the vehicle body 12 is rotated an additional 90 degrees exposing the underside of the vehicle body 8G if underbody paint application is required. Camming arms 88 engage fourth cam 98 and fifth cam 100, which retains the vehicle body 12 is the desired orientation.

To complete the rotation of movement of the vehicle body 12, the cam arms 88 engage the sixth cam 102, the seventh cam 104, the eighth cam 108 and the ninth cam 108, which returns the vehicle to an upright position associated with interaction of the first cam 92. Once the vehicle body is returned to the upright position, the paint application process is completed and the vehicle body 12 is transferred to the oven to cure the paint. While the preferred embodiment is the cams described above and shown in FIGS. 9A through 9H, there is other methods to rotate the vehicle body 12 are contemplated, including but not limited to gears and servomotors.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, wherein reference numerals are merely for convenience and are not to be in any way limiting, the invention may be practiced otherwise than as specifically described.

What is claimed is:

1. A paint application facility, comprising:
a paint application chamber having a chamber length selected to serially process a plurality of the vehicle bodies moving through said paint application chamber and a chamber width defined by opposing walls;
a paint applicator disposed inside said paint application chamber for applying atomized paint to the vehicle body;
a plurality of carriers adapted to support said vehicle bodies for moving the vehicle bodies through said paint application chamber; and
wherein said carriers are serially moved through said paint application chamber by a conveyor disposed outside said opposing walls.

2. A facility as set forth in claim 1, wherein each of said carriers define a longitudinal axis associated with a length of the vehicle and said conveyor moves said carriers in a generally perpendicular direction to said longitudinal axis.

3. A facility as set forth in claim 1, wherein each of said carriers include an elongated member having a distal end extending outwardly through said opposing walls and being operably connected to said conveyor.

4. A facility as set forth in claim 1, wherein said carriers are adapted to rotate generally around said longitudinal axis thereby rotating the vehicle.

5. A facility as set forth in claim 4, further including rotary apparatus operably connected to said elongated member thereby translating rotational movement to said carrier.

6. A facility as set forth in claim 5, wherein said rotary apparatus includes a cam arm and a cam oriented to engage said cam arm thereby rotating said vehicle body.

7. A facility as set forth in claim 6, wherein said cam arm includes an annular shape adapted to receive said cam surface thereby reducing frictional forces between said rotational member and said cam.

8. A facility as set forth in claim 5, wherein said rotary apparatus is located outside said paint application chamber.

9. A facility as set forth in claim 1, wherein said paint applicators are positioned above said vehicle inside said paint application chamber.

10. A facility as set forth in claim 9, wherein said paint applicators are adapted to apply paint to the vehicle while the vehicle is rotated by said rotary apparatus.

11. A paint booth assembly for applying paint to automotive vehicles each defining a longitudinal axis, comprising a carrier adapted to serially move a plurality of automotive vehicles through said booth assembly in a direction generally perpendicular to the longitudinal axis of the vehicle.

12. An assembly as set forth in claim 11, wherein said carrier comprises a plurality of frames each adapted to support one of said vehicles.

13. An assembly as set forth in claim 12, wherein each of said frames are operably connected to a conveyor disposed outside said assembly.

14. An assembly as set forth in claim 11, wherein each of said carriers are rotatably supported by said conveyor thereby allowing said vehicle to rotate around the vertical axis defined by the vehicle.

15. An assembly as set forth in claim 14, further including a rotary apparatus for translating rotational movement to each of said carriers thereby rotating said carrier around the longitudinal axis of the vehicle.

16. An assembly as set forth in claim 15, wherein said rotary apparatus comprises a cam arm fixedly attached to each of said carriers and a cam engageable with said cam arm thereby translating rotational movement to said carrier.

17. An assembly as set forth in claim 14, further comprising a paint applicator disposed above said carrier oriented to apply paint to horizontal and vertical surfaces of the vehicle while said carrier rotates the vehicle.

18. An assembly as set forth in claim 17, wherein said paint applicator comprises a robot arm having a paint atomizer disposed thereon and being moveable relative to said rotating carrier.

19. An assembly as set forth in claim 17, wherein said paint applicator comprises a reciprocating devices having a paint atomizer dispose thereon and being moveable relative to said rotating carrier.

20. An assembly as set forth in claim 11, wherein each of said carriers includes a length and are serially spaced a distance of generally one third the length of said carrier.

21. A method of applying paint to a plurality of vehicles, each defining a longitudinal axis, comprising the steps of:
moving the vehicles through a paint booth in a direction generally perpendicular to the longitudinal axis of each vehicle;
rotating the vehicle around the longitudinal axis of the vehicle;
providing a paint applicator spaced above the vehicles; and
applying paint to at least one of the vehicles in a downward direction while the vehicle is rotating around the longitudinal axis of the vehicle.

22. The method set forth in claim 21, further comprising the step of serially moving the plurality of vehicles through said paint booth.

23. The method set forth in claim 21, further comprising the step of providing a paint applicator at space locations, each paint applicator being correlated to a rotational orientation of the vehicle.

24. The method set forth in claim 21, further comprising the step of providing a conveyor disposed outside said paint booth and being operably connected to the plurality of vehicles thereby moving the plurality of vehicles through said paint booth.

25. A paint application facility for applying paint to vehicle bodies having a longitudinal axis; comprising
a plurality of vehicle carriers each supporting a vehicle body along the longitudinal axis;
a plurality of manual work stations whereat manual operations are performed upon the vehicle bodies;
a paint application booth defined by opposing walls wherein atomized paint is applied by a paint applicator to the vehicle bodies;
a curing oven receiving painted vehicle bodies from said paint application booth for curing paint applied to the vehicle bodies by said paint applicator; and
a conveyor assembly conveying the vehicles substantially in a direction of the longitudinal axis through said plurality of manual work stations and conveying the vehicles in a direction substantially perpendicular to the longitudinal axis through said paint application booth and said curing oven.

26. The facility set forth in claim 25, comprising a first conveyor and a second conveyor disposed within at least said paint application booth, wherein said first conveyor and said second conveyor support opposing ends of said vehicle carriers.

27. The facility set forth in claim 26, wherein said first conveyor and said second conveyor are located adjacent said opposing walls of said paint application booth.

28. The facility set forth in claim 26, wherein said first conveyor and said second conveyor are disposed outside said opposing walls of said paint application booth.

29. The facility set forth in claim 28, wherein each of said opposing walls include a slot having said carrier extending therethrough and being operably connected to said conveyor assembly.

30. The facility set forth in claim 25, wherein said conveyor assembly is disposed in a conveyor chamber.

31. The facility set forth in claim 30, wherein said conveyor chamber includes a first air pressure and said paint application chamber includes a second air pressure, said second air pressure being less than said first air pressure.

32. The facility set forth in claim 25, wherein one of said carrier includes a rotary apparatus for rotating said vehicle body inside said paint application chamber.

33. The facility set forth in claim 25, wherein said paint applicator is disposed above said vehicle bodies for atomizing paint in a downward direction.

34. The facility set forth in claim 25, comprising a pretreatment station wherein said vehicle bodies are conveyed through said pretreatment station in a substantially perpendicular direction the longitudinal axis of said vehicle bodies.

35. The facility set forth in claim 25, comprising an electrodeposition primer station wherein said vehicle bodies are conveyed through said pretreatment station in a substantially perpendicular direction the longitudinal axis of said vehicle bodies.

36. An electrodeposition primer tank, comprising a conveyor assembly for serially conveying vehicle bodies through said tank and a plurality of carriers for supporting the vehicle bodies, each carrier being oriented in a substantially normal relationship to a longitudinal axis defined by each vehicle body thereby moving the vehicles through said tank in a substantially normal direction to the longitudinal axis defined by each vehicle body.

37. The electrodeposition primer tank set forth in claim 36, further including a rotary apparatus cooperable with said carriers thereby providing rotational movement to said vehicle bodies being conveyed through said tank around the longitudinal axis defined by the vehicle bodies.

38. A paint application facility for serially painting vehicle bodies defining a longitudinal axis and being conveyed through said facility, comprising:
a paint booth for applying paint to the vehicle bodies;
a manual work station for performing manual operations upon said vehicle bodies; and
a carrier assembly serially conveying the vehicle bodies through said paint application facility, wherein said carrier assembly is oriented to convey the vehicle bodies in a direction substantially perpendicular to the longitudinal axis defined by each vehicle body through at least said paint booth.

39. A paint application facility as set forth in claim 38, wherein said carrier assembly serially conveys the vehicle bodies through said manual work station in a direction generally coaxial with said longitudinal axis defined by each vehicle body.

40. A paint application facility as set forth in claim 38, wherein said carrier assembly comprises first and second conveyors in a spaced relationship at least in said paint booth.

41. A paint application facility as set forth in claim 38, wherein said paint booth includes opposing side walls and one each of said first and second conveyors are positioned adjacent one of said opposing side walls.

42. A paint application facility as set forth in claim 41, wherein said first and second conveyors are disposed outside said paint booth.

43. A paint application facility as set forth in claim 42, wherein said first and second carriers support opposing ends of each vehicle body.

44. A paint application facility as set forth in claim 38, further including a paint curing oven positioned in said paint facility to receive vehicle bodies from said paint booth conveyed in a direction substantially perpendicular to the longitudinal axis defined by each vehicle body.

45. A paint application facility having a booth assembly for applying paint to automotive vehicle bodies each defining a longitudinal axis, comprising a carrier adapted to serially move a plurality of automotive vehicles through said booth assembly in a direction generally perpendicular to the longitudinal axis of the vehicle.

46. A facility as set forth in claim 45, wherein said carrier comprises a plurality of frames each adapted to support one of said vehicles.

47. A facility as set forth in claim 46, wherein each of said frames are operably connected to a conveyor disposed outside said assembly.

48. A facility as set forth in claim 45, wherein each of said carriers are rotatably supported by said conveyor thereby allowing said vehicle to rotate around the vertical axis defined by the vehicle.

49. A facility as set forth in claim 45, further including a rotary apparatus for translating rotational movement to each of said carriers thereby rotating said carrier around the longitudinal axis of the vehicle.

50. A facility as set forth in claim 45, wherein said rotary apparatus comprises a cam arm fixedly attached to each of said carriers and a cam engageable with said cam arm thereby translating rotational movement to said carrier.

51. A facility as set forth in claim 50, further comprising a paint applicator disposed above said carrier oriented to apply paint to horizontal and vertical surfaces of the vehicle while said carrier rotates the vehicle.

52. A facility as set forth in claim 51, wherein said paint applicator comprises a robot arm having a paint atomizer disposed thereon and being moveable relative to said rotating carrier.

53. A facility as set forth in claim 51, wherein said paint applicator comprises a reciprocating devices having a paint atomizer dispose thereon and being moveable relative to said rotating carrier.

54. A facility as set forth in claim 45, wherein each of said carriers includes a length and are serially spaced a distance of generally one third the length of said carrier.
